(19) United States
(12) Patent Application Publication
(10) Pub. No.: US 2010/0048780 A1
(43) Pub. Date: Feb. 25, 2010

(54) PREVENTION OF COLOR FORMATION IN POLYOLEFINS

(75) Inventor: Elisabeth Serafeim Papazoglou, Yardley, PA (US)

Correspondence Address: RATNERPRESTIA, P.O. BOX 980, VALLEY FORGE, PA, 19482, US

(73) Assignee: Polymer Products Company, Inc., Stockertown, PA (US)

(21) Appl. No.: 12/542,191

(22) Filed: Aug. 17, 2009

Related U.S. Application Data
(60) Provisional application No. 61/091,123, filed on Aug. 22, 2008.

(51) Int. Cl. C08K 5/524; C08K 5/52

(52) U.S. Cl. 524/128; 524/140

(57) ABSTRACT

Compositions that have been stabilized to prevent gas fading are disclosed. The compositions comprise a polyolefin, a phenolic antioxidant, and at least of either a phosphite stabilizer or a hydroxyl amine stabilizer. Unlike previous stabilizer systems, which have used “phenolic free” polymers, the inventive stabilizer system can stabilize polyolefins against gas fading in the presence of a phenolic antioxidant.

### CROSS-REFERENCE TO RELATED APPLICATIONS

This application claims the benefit of U.S. Provisional Application No. 61/091,123, filed Aug. 22, 2008, and incorporated herein by reference in its entirety for all purposes.

### FIELD OF THE INVENTION

This invention relates to gas fading of polymers. In particular, this invention relates to phenolic antioxidant containing compositions that have been stabilized to prevent gas fading.

### BACKGROUND OF THE INVENTION

Polyolefin containing compositions stabilized with phenolic antioxidants, especially polyethylene or polypropylene produced with a transition metal catalyst (such as titanium, vanadium, zirconium or chromium), tend to discolor when exposed to air pollutants such as NOₓ gas. This phenomenon, known as “gas fading”, is described as discoloration resulting from the exposure of plastic articles to an atmosphere containing oxides of nitrogen. Gas fading is thought to be caused by oxidation of phenolic antioxidants by, for example, nitrogen oxides, to generate colored byproducts.

One approach to preventing gas fading is the use of stabilized “phenol-free” polyolefins. This approach is discussed for example, in Tikuisis, U.S. Pat. No. 7,361,703, the disclosure of which is incorporated herein by reference. However, use of a “phenol-free” polyolefin is frequently not practical. Phenolic antioxidants can be necessary to prevent degradation of the polyolefin during post-production processing. Removal of the phenolic antioxidant from the polyolefin can adversely affect performance of the polyolefin during, for example, melt processing, spinning, or extrusion. In addition, commercially available polyolefins typically contain phenolic antioxidants. For small volume applications, it may not be commercially feasible to remove the phenolic antioxidants added by the supplier as part of the “typical” stabilizer package or to obtain a “phenol-free” polyolefin from the supplier. Further, stabilized “phenol-free” polyolefins typically contain expensive non-phenolic antioxidants and are frequently not practical replacements for phenolic antioxidants. Thus, a need exists for preventing gas fading in phenolic antioxidant containing polyolefins.

### SUMMARY OF THE INVENTION

The invention provides a phenolic antioxidant containing composition that has been stabilized to reduce or prevent gas fading. The composition comprises:

a) an organic polymer that is susceptible to gas fading;

b) a phenolic antioxidant; and at least one of c) or d):

c) a phosphite stabilizer comprising a compound selected from the group consisting of bis(2,4-dicumylphenyl)pentaerythritol diphosphite, bis(2,4-di-tert-butylphenyl)pentaerythritol diphosphite, tris(2,4-di-tert-butylphenyl) phosphite, and mixtures thereof;

d) a hydroxyl amine stabilizer.

In one aspect of the invention, the organic polymer that is susceptible to gas fading is a polyolefin. In another aspect of the invention, the polyolefin is polyethylene, polypropylene, their respective copolymers, or a mixture thereof. In another aspect of the invention, the polyolefin is a thermoplastic polyolefin (TPO).

One significant advantage of the invention is that it permits the use of polymers containing phenolic antioxidants while avoiding or lessening the problems with pink color formation typically encountered with phenolic antioxidant-stabilized polymers. Utilizing the present invention, a formulator will have the flexibility to employ conventional bulk polymers which already contain phenolic antioxidant and which are available at a relatively low cost (compared to “phenol-free” grades) to produce products which have a reduced tendency to exhibit color body formation. The present invention also provides the formulator with the capability to correct pinking problems after they arise by reworking the pink polymer with one or both of a phosphite stabilizer and a hydroxyl amine stabilizer as described herein.

### DETAILED DESCRIPTION OF THE INVENTION

Unless the context indicates otherwise, in the specification and claims the terms polymer that is susceptible to gas fading, polyolefin, phenolic antioxidant, hydroxyl amine stabilizer, additive, colorant, and similar terms also include mixtures of such materials.

The invention provides a composition that has been stabilized to reduce or prevent gas fading. The composition comprises a polymer that is susceptible to gas fading and a phenolic antioxidant. The composition additionally comprises bis-(2,4-dicumylphenyl)pentaerythritol diphosphite, and/or a similar material, and/or a hydroxylamine stabilizer. For example, phosphites that are similar to bis-(2,4-dicumylphenyl)pentaerythritol diphosphite can be used in place of, or in addition to, the bis-(2,4-dicumylphenyl)pentaerythritol diphosphite. The phosphite stabilizer must be compatible with the other additives present in the composition and must not adversely affect the properties of the composition required for the proposed application.

Bis-(2,4-dicumylphenyl)pentaerythritol diphosphite (CAS#154862-43-8) is disclosed in Stevenson U.S. Pat. Nos. 5,364,895, and 5,438,086, each of which is incorporated herein by reference in its entirety for all purposes. It is available from Dover Chemical (Dover, Ohio USA) as DOVERPHOS® S-9228 stabilizer. The composition typically comprises about 0.05 wt % to about 1.0 wt %, more typically about 0.08 to about 0.80 wt %, preferably about 0.10 to about 0.50 wt %, more preferably about 0.15 wt % to about 0.40 wt %, most preferably about 0.20 wt % to about 0.25 wt % of bis-(2,4-dicumylphenyl)pentaerythritol diphosphite. When a similar material or materials is used in place of, or in addition to, the bis-(2,4-dicumylphenyl)pentaerythritol diphosphite, the composition typically comprises a total of about 0.05 wt % to about 1.0 wt %, more typically about 0.08 to about 0.80 wt %, preferably about 0.10 to about 0.50 wt %, more preferably about 0.15 wt % to about 0.40 wt %, most preferably about 0.20 wt % to about 0.25 wt % of the bis-(2,4-dicumylphenyl)pentaerythritol diphosphite and similar materials.

### Hydroxylamine Stabilizers

The composition may optionally comprise a hydroxylamine stabilizer or a mixture of hydroxylamine stabilizers. Hydroxylamine stabilizers are well known and are described, for example, in Seltzer, U.S. Pat. No. 4,590,231, and Ravichandran, U.S. Pat. No. 4,782,105, the disclosures of each of which are incorporated herein by reference in their entirety for all purposes.

Useful hydroxylamine stabilizers include, for example, N,N-dibenzylhydroxylamine, N,N-diethylhydroxylamine, N,N-dibutylhydroxylamine, N,N-dihexylhydroxylamine, the N,N-dialkylhydroxylamine derived from oxidation of hydrogenated tallow amine, and hydroxyl amines of the general formula RN(OH)R′, in which R and R′ are each independently alkyl groups of eight to eighteen carbon atoms, such as N,N-dioctylhydroxylamine, N,N-didecylhydroxylamine, N,N-didodecylhydroxylamine, N,N-ditetradecylhydroxylamine, N,N-dihexadecylhydroxylamine, N,N-dioctadecylhydroxylamine, N-hexadecyl-N-octadecylhydroxylamine, and N-heptadecyl-N-octadecylhydroxylamine.

The choice of hydroxylamine stabilizer and amount used in the composition will depend on the nature of the polymer that is susceptible to gas fading in the composition, other additives that are present in the composition, and the proposed application for the composition. For example, hydroxylamine stabilizers with long aliphatic chains, such as N,N-didecylhydroxylamine, N,N-didodecylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine and the N,N-dialkylhydroxylamine derived from oxidation of hydrogenated tallow amine, may be more useful in the stabilization of polymers such as polyethylene, polypropylene, and copolymers and mixtures thereof. The hydroxylamine stabilizer must be compatible with the other additives present in the composition and must not adversely affect the properties of the composition required for the proposed application.

The composition typically comprises about 0.05 wt % to about 1.0 wt %, more typically about 0.08 to about 0.80 wt %, preferably about 0.10 to about 0.50 wt %, more preferably about 0.15 wt % to about 0.40 wt %, most preferably about 0.20 wt % to about 0.25 wt % of the hydroxylamine stabilizer or a mixture of hydroxylamine stabilizers. However, in one embodiment of the invention, less than about 0.05 wt % hydroxylamine stabilizer is present in the composition.

### Phenolic Antioxidant

Unlike previous “phenol free” stabilized polyolefin compositions, such as those disclosed and discussed in Tikuisis, U.S. Pat. No. 7,361,703, the compositions of the invention comprise a phenolic antioxidant. Depending on the amount of phenolic antioxidant added by the manufacturer, the composition typically comprises about 0.01 wt % to about 1.0 wt %, more typically about 0.02 wt % to about 0.8 wt %, even more typically about 0.05 wt % to about 0.5 wt % of the phenolic antioxidant. Amounts of about 0.08 wt to about 0.40 wt %, for example about 0.08 wt %, about 0.20 wt %, or about 0.1 wt % are commonly used.

Phenolic antioxidants include, for example, the following groups of antioxidants: alkylated mono-phenols, such as, 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-iso-butylphenol, 2,6-dicyclopentyl-4-methylphenol, 2-(α-methylcyclohexyl)-4,6dimethylphenol, 2,6-di-octadecyl-4-methylphenol, 2,4,6-tricyclohexyphenol, and 2,6-di-tert-butyl-4-methoxymethylphenol; alkylated hydroquinones, such as, 2,6-di-tert-butyl-4-methoxyphenol, 2,5-di-tert-butylhydroquinone, 2,5-di-tert-amyl-hydroquinone, and 2,6-diphenyl-4-octadecyloxyphenol; hydroxylated thiodiphenyl ethers, such as, 2,2′-thio-bis-(6-tert-butyl-4-methylphenol), 2,2′-thio-bis-(4-octylphenol), 4,4′-thio-bis-(6-tert-butyl-3-methylphenol), and 4,4′-thio-bis-(6-tert-butyl-2-methylphenol); alkylidene-bisphenols, such as 2,2′-methylene-bis-(6-tert-butyl-4-methylphenol), 2,2′-methylene-bis-(6-tert-butyl-4-ethylphenol), 2,2′-methylene-bis-(4-methyl-6-(α-methylcyclohexyl)phenol), 2,2′-methylene-bis-(4-methyl-6-cyclohexylphenol), 2,2′-methylene-bis-(6-nonyl-4-methylphenol); 2,2′-methylene-bis-(6-nonyl-4-methylphenol), 2,2′-methylene-bis-(6-α-methylbenzyl)-4-nonylphenol), 2,2′-methylene-bis-(6-(α,α-dimethylbenzyl)-4-nonyl-phenol), 2,2′-methylene-bis-(4,6-di-tert-butylphenol), 2,2′-ethylidene-bis-(6-tert-butyl-4-iso-butylphenol), 4,4′methylene-bis-(2,6-di-tert-butylphenol), 4,4′-methylene-bis-(6-tert-butyl-2-methylphenol), 1,1-bis-(5-tert-butyl-4-hydroxy-2-methylphenol)butane 2,6-di-(3-tert-butyl-5-methyl-2-hydroxybenzyl)-4-methylphenol, 1,1,3-tris-(5-tert-butyl-4-hydroxy-2-methylphenyl)butane, 1,1-bis-(5-tert-butyl-4-hydroxy-2-methylphenyl)-3-dodecyl-mercaptobutane, ethyleneglycol-bis-(3,3-bis-(3′-tert-butyl-4′-hydroxyphenyl)-butyrate)-di-(3-tert-butyl-4-hydroxy-5-methylpenyl)-dicyclopentadiene, di-(2-(3′-tert-butyl-2′-hydroxy-5′-methylbenzyl)-6-tert-butyl-4-methylphenyl-terephthalate; and other phenolics such as monoacrylate esters of bisphenols such as ethylidiene bis-2,4-di-tert-butylphenol monoacrylate ester; benzyl compounds, such as, 1,3,5-tris-(3,5-di-tert-butyl-4-hydroxybenzyl)-2,4,6-trimethylbenzene, bis-(3,5-di-tert-butyl-4-hydroxybenzyl)-sulfide, iso-octyl 3,5-di-tert-butyl-4-hydroxybenzylmercaptoacetate; bis-(4-tert-butyl-3-hydroxy-2,6-dimethylbenzyl)-dithiol-terephthalate, 1,3,5-tris-(3,5-di-tert-butyl-4,10-hydroxybenzyl)-isocyanurate, 1,3,5-tris-(4-tert-butyl-3-hydroxy-2,6-dimethylbenzyl)-isocyanurate, dioctadecyl 3,5-di-tert-butyl-4-hydroxybenzylphosphonate, calcium salt of monoethyl 3,5-di-tert-butyl-4-hydroxybenzylphosphonate, and 1,3,5-tris-(3,5-dicyclohexyl-4-hydroxybenzyl)-isocyanurate; acylaminophenols, such as 4-hydroxy-lauric acid anilide; 4-hydroxy-stearic acid anilide, 2,4-bis-octylmercapto-6-(3,5-tert-butyl-4-hydroxyanilino)-s-triazine, and octyl-N-(3,5-di-tert-butyl-4-hydroxyphenyl)-carbamate; esters of β-(5-tert-butyl-4-hydroxy-3-methylphenyl)-propionic acid with monohydric or polyhydric alcohols, such as, methanol, diethyleneglycol, octadecanol, triethyleneglycol, 1,6-hexanediol, pentaerythritol, neo-pentylglycol, tris-hydroxyethyl isocyanurate, thidiethyleneglycol, and dihydroxyethyl oxalic acid diamide; and amides of β-(3,5-di-tert-butyl-4-hydroxyphenol)-propionic acid, for example, N,N′-di-(3,5-di-tert-butyl-4-hydroxyphenylpropionyl)-hexamethylendiamine, N,N′-di-(3,5-di-tert-butyl-4-hydroxyphenylpropionyl)-trimethylenediamine, and N,N′-di(3,5-di-tert-butyl-4-hydroxyphenylpropionyl)-hydrazine. A common stabilizer is “Antioxidant 1010” [IRGANOX® 1010], pentaerythritol tetra-[β-(3,5-di-tert-butyl-4-hydroxyphenyl)-propionate] [CAS#6683-19-8].

### Organic Polymers

The composition comprises at least one organic polymer that is susceptible to gas fading. Examples of organic polymers are disclosed, for example in Kaprinidis, U.S. Pat. No. 7,109,260, column 3, line 50, to column 7, line 30, the disclosure of which is incorporated herein by reference in its entirety for all purposes.

Polyolefins are susceptible to gas fading. The polymer can comprise a polyolefin or a mixture of polyolefins. These are polymers and copolymers of mono-olefins and di-olefins such as ethylene, propylene, 1-butenene, 1-octene, iso-butylene, butadiene, and isoprene. Polymers of mono-olefins and di-olefins, for example polypropylene, polyisobutylene, polybut-1-ene, poly-4-methylpent-1-ene, polyvinylcyclohexane, polyisoprene or polybutadiene, as well as polymers of cyclo-olefins, for instance of cyclopentene or norbornene, polyethylene, for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), very low density polyethylene (VLDPE) and ultra low density polyethylene (ULDPE). Mixtures of polyolefins include, for example, mixtures of polypropylene with polyisobutylene, polypropylene with polyethylene and mixtures of different types of polyethylene. Copolymers of monoolefins and diolefins with each other or with other vinyl monomers, include, or example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefin copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with mono-olefins and di-olefins such as ethylene, propylene, 1-butenene, 1-octene, iso-butylene, butadiene, and isoprene, for example polypropylene/ethylenepropylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

Thermoplastic polyolefins (TPO), for example, polypropylene/TPO can be stabilized against gas fading. Thermoplastic polyolefins include polymer/filler blends usually consisting of some fraction of polypropylene, polyethylene, block copolymer polypropylene (BCPP), rubber, and a reinforcing filler. Typical fillers include, for example, talc, fiberglass, carbon fiber, wollastonite, and metal oxysulfate (MOS). Common rubbers include ethylene-propylene rubber (EPR), EP-diene rubber (EPDM), ethylene-octene (EO), ethylene-butadiene (EB), styrene-ethylene-butadiene-styrene (SEBS). Plasticizers are typically absent from thermoplastic polyolefins. The stabilized polyolefin/TPO polymers, such as propylene/TPO, can be formulated with other polymers such as polyvinyl chloride.

Preferred polyolefins for use in the compositions of the invention are polyethylene, polypropylene, ethylene/propylene copolymers and mixtures and blends thereof with each other, with other polymers such as rubbers, and/or with other materials such as fillers.

### Other Additives

Depending on the nature and intended application of the composition, additives other than phenolic antioxidants, bis-(2,4-dicumylphenyl)pentaerythritol diphosphite and hydroxylamine stabilizers can be present in the composition. Polymer additives include, for example, colorants, typically dyes or pigments such as titanium dioxide, copper phthalocyanine, and carbon black; acid neutralizers; metal deactivators; fillers; reinforcing agents; anti-static agents; brighteners; flame retardants; hindered amines; absorbers such as benztriazoles and hydroxy benzophenones; other phosphite stabilizers such as tris(2,4-di-tert-butylphenyl) phosphite, bis(2,4-di-tert-butylphenyl) pentaerythritol diphosphite, di-tert-butyl phenyl phosphite, and tris-(2,4-di-tert-octylphenyl) phosphite; and other thermal and photochemical stabilizers. Other stabilizers, for example phosphite stabilizers, added by the manufacturer of the polymer, can be present in the composition. These additives and their use are well known to those skilled in the art of polymer formulation. Polymer additives are disclosed, for example, in Tikuisis, U.S. Pat. No. 7,361,703, the disclosure of which is incorporated herein by reference in its entirety for all purposes.

### Preparation

In one embodiment, the invention is a method for the preparation of the composition that has been stabilized against gas fading. Typically, the bis-(2,4-dicumylphenyl)pentaerythritol diphosphite and/or hydroxyl amine stabilizer are added to the polymer that is susceptible to gas fading, which contains the phenolic antioxidant and any other additives added by the manufacturer. Other additives, such as colorants, can be added at the same time, if desired. However, it is not necessary to add a hindered amine to the polymer. Although a hindered amine stabilizer, such as one that contains the 2,2,6,6-tetramethylpiperidine moiety, may be present in the additive package added by the manufacturer, it has suggested that gas fading is aggravated by the presence of a hindered amine light stabilizer in the composition.

Any method that provides uniform mixing of the ingredients can be used. One procedure involves the steps of dry blending all of the ingredients to homogeneity followed by fluxing the dry blend at elevated temperatures and then extruding the melt blend, cooling and then dicing into cubed or pelletized form. Alternatively, the bis-(2,4-dicumylphenyl)pentaerythritol diphosphite and hydroxyl amine stabilizer (if both are to be part of the desired composition) can be blended together as an additive package. Alternatively, all of the additives can be added to a small amount of the polymer, for example about 1 to about 20 parts, instead of 100 parts, to produce a master batch. The user adds the additive package or the master batch to polymer and extrudes a melt blend.

### INDUSTRIAL APPLICABILITY

The compositions of the invention are especially useful for the production of molded, extruded, or spun plastic articles that would otherwise be subject to undesired discoloration due to gas fading, such as for example, fabrics, films and tapes, cases for electric appliances and electronic devices such as microwave ovens and personal computers, and automotive parts such as moldings for various applications such as dashboards.

The advantageous properties of this invention can be observed by reference to the following examples, which illustrate but do not limit the invention.

### EXAMPLES

### Glossary

| | |
|---|---|
| DOVERPHOS ® S-9228 | Bis-(2,4-dicumylphenyl)pentaerythritol diphosphite (CAS# |
| | 154862-43-8) (Dover Chemical, Dover OH USA) |
| Grey Colorant | Polymer concentrate comprising carbon black and titanium |
| | dioxide pigments |
| IRGASTAB ® FS 301 | Mixture of tris(2,4-di-tert-butylphenyl) phosphite and the N,N- |
| | dialkylhydroxylamine derived from oxidation of hydrogenated |
| | tallow amine (Ciba Specialty Chemicals, Tarrytown, NY USA) |
| Polypropylene/TPO | Commercially available polypropylene/TPO resin containing a |
| | phenolic antioxidant |
| ULTRANOX ® 626 | Bis (2,4-di-tert-butylphenyl) pentaerythritol diphosphite (CAS # |
| | 26741-53-7) (Chemtura, Middlebury, CT USA) |

### Examples 1-4

This Example shows polypropylene/TPO resin containing a phenolic antioxidant and a grey colorant, with and without the addition of stabilizers. The samples shown in Table 1 were prepared and evaluated as described below. Each resin mixture contained 6.25 wt % of a grey color concentrate.

TABLE 1

| Ex- | Poly- | | | |
|---|---|---|---|---|
| am- | propylene | IRGASTAB ® | ULTRANOX ® | DOVERPHOS ® |
| ple # | TPO^{a} | FS-301 | 626 | 9228 |
| C1 | 93.75 | — | — | — |
| 1 | 93.45 | 0.3 | — | — |
| 2 | 93.25 | 0.5 | — | — |
| 3 | 93.25 | 0.3 | 0.2 | — |
| 4 | 93.25 | 0.3 | — | 0.2 |

^{a}Each resin mixture also contained 6.25 wt % of a grey color concentrate.

Samples were exposed to NOₓ in an exposure chamber following the general procedure of American Association of Textile Chemists (AATTC) Test Method 23-2005, “Colorfastness to Burnt Gas Fumes”. Each sample was suspended in a test chamber so that it was not in contact with another sample and exposed to an atmosphere of air that had passed over and contained the byproducts of combustion from a lighted gas burner. The conditions were adjusted so that the temperature in the chamber did not exceed 60° C. Exposure was carried out until the control sample (Example C1) showed a visible color change, typically about forty eight hours at about 60° C.

The Hunter ΔL, Δa, Δb, and ΔE values were determined for each sample using a Gretag-Macbeth-2180 instrument. A positive ΔL means that the sample is lighter than the standard. A negative ΔL means that the sample is darker than the standard. A positive Δa means that the sample is redder than the standard. A negative Δa means that the sample is greener than the standard. A positive Δb means that the sample is yellower than the standard. A negative Δb means that the sample is bluer than the standard. ΔE is the total color difference between the sample and the standard. The smaller the absolute value of ΔL, Δa, Δb and ΔE, the less color shift is visible. The results are shown in Table 2.

TABLE 2

| Example # | ΔL | Δa | Δb | ΔE |
|---|---|---|---|---|
| C | −2.69D | 3.08R | 0.74Y | 4.16 |
| 1 | −1.72D | 1.94R | 0.13Y | 2.60 |
| 2 | −0.98D | 1.44R | −0.07E | 1.74 |
| 3 | −1.24D | 1.81R | −0.11Y | 2.20 |
| 4 | −0.69D | 1.28R | −0.40E | 1.51 |

These results demonstrate that incorporation of IRGASTAB® 310 (a mixture of a phosphite and a dialkylhydroxylamine) (Examples 1 and 2) reduces discoloration over the control (Example C), but a change in the color of the article is still observed. The combination of IRGASTAB® 310 and ULTRANOX® 626 (a phosphite) reduces discoloration (Example 3), but the best color stability is observed (Example 4) with a combination of IRGASTAB® 310 and DOVERPHOS® 9228 (bis-(2,4-dicumylphenyl)pentaerythritol diphosphite). As demonstrated by Example 4 in Table 2, by increasing the dosage/addition level of DOVERPHOS® 9228 and IRGASTAB® FS-301, a further improvement in performance is observed. The optimal levels of the different additives will be determined by the cost of the formulation and the compatibility/blooming issues related to the particular polymer and application.

Having described the invention, we now claim the following and their equivalents.

What is claimed is:

1. A composition comprising:
a) a polymer susceptible to gas fading;
b) a phenolic antioxidant; and at least one of c) or d):
c) a phosphite stabilizer comprising a compound selected from the group consisting of bis(2,4-dicumylphenyl)pentaerythritol diphosphite, bis(2,4-di-tert-butylphenyl)pentaerythritol diphosphite, tris(2,4-di-tert-butylphenyl) phosphite, and mixtures thereof;
d) a hydroxyl amine stabilizer.

2. The composition of claim 1 in which the polymer susceptible to gas fading is a polyolefin.

3. The composition of claim 2 in which the polyolefin is selected from the group consisting of polyethylene, polypropylene, ethylene/propylene copolymers and mixtures thereof.

4. The composition of claim 2 in which the polyolefin is polyethylene.

5. The composition of claim 2 in which the polyolefin is polypropylene.

6. The composition of claim 2 in which the polyolefin is a thermoplastic polyolefin.

7. The composition of claim 1 comprising both c) and d).

8. The composition of claim 1 in which the hydroxyl amine stabilizer is present and is selected from the group consisting of the N,N-dialkylhydroxylamine derived from oxidation of hydrogenated tallow amine, hydroxyl amines of the general formula RN(OH)R′, in which R and R′ are each independently alkyl groups of eight to eighteen carbon atoms, and mixtures thereof.

9. The composition of claim 1 in which the composition comprises about 0.05 wt % to about 1.0 wt % of the phosphite stabilizer.

10. The composition of claim 1 in which the composition comprises about 0.05 wt % to about 1.0 wt % of the hydroxyl amine stabilizer.

11. The composition of claim 1 in which the composition comprises about 0.10 wt % to about 0.50 wt % of the phosphite stabilizer.

12. The composition of claim 1 in which the composition comprises about 0.10 wt % to about 0.50 wt % of the hydroxyl amine stabilizer.

13. The composition of claim 1 in which the composition comprises about 0.15 wt % to about 0.40 wt % of the phosphite stabilizer.

14. The composition of claim 1 in which the composition comprises about 0.15 wt % to about 0.40 wt % of the hydroxyl amine stabilizer.

15. The composition of claim 1 in which the composition comprises about 0.05 wt % to about 0.05% of the phenolic antioxidant.

16. The composition of claim 1 in which the phenolic antioxidant is pentaerythritol tetra-[β-(3,5-di-tert-butyl-4-hydroxyphenyl)-propionate].

17. The composition of claim 1 in which the composition additionally comprises a colorant.

18. The composition of claim 1 comprising bis(2,4-dicumylphenyl)pentaerythritol diphosphite and a second phosphite stabilizer.

19. The composition of claim 18 in which the second phosphite stabilizer is tris(2,4-di-tert-butylphenyl) phosphite.

20. A method for preparing the composition of claim 1, the method comprising the step of adding at least one of a phosphite stabilizer or hydroxyl amine stabilizer to a composition that comprises the phenolic antioxidant and the polymer that is susceptible to gas fading.

21. The method of claim 20 in which a hindered amine light stabilizer is not added.
